(19) United States
(12) Patent Application Publication
(10) Pub. No.: US 2019/0357723 A1
(43) Pub. Date: Nov. 28, 2019

(54) ELECTROLYTIC IRON COOKING IMPLEMENT

(71) Applicant: Lucky Iron Fish, Inc., Guelph (CA)

(72) Inventor: Gavin Armstrong, Guelph (CA)

(21) Appl. No.: 16/332,697

(22) PCT Filed: Sep. 12, 2017
(86) PCT No.: PCT/IB2017/055504

§ 371 Date: Mar. 12, 2019

Related U.S. Application Data
(60) Provisional application No. 62/393,236, filed on Sep. 12, 2016.

(51) Int. Cl. A47J 36/16; A23L 5/10; A23L 33/16; B22F 3/03

(52) U.S. Cl. CPC A47J 36/16; A23L 5/10; A23L 33/16; B22F 2304/05; A23V 2002/00; B22F 2301/35; B22F 3/03

(57) ABSTRACT

A method is described for releasing bioavailable iron into water used for cooking by placing one or more iron cooking implements into the water. The cooking implements are prepared by compacting electrolytic iron.

### CROSS-REFERENCE TO RELATED APPLICATION

This application claims the benefit of U.S. Provisional Application Ser. No. 62/393,236 filed Sep. 12, 2016, the disclosure of which is incorporated herein by reference.

### TECHNICAL FIELD

The present disclosure relates generally to cooking implements to be added during cooking for increasing bioavailable iron.

### BACKGROUND

Iron deficiency is one of the most significant micronutrient deficiencies in the world. It predominantly affects women (especially those of reproductive age), has significant effects on the physical and mental growth and development in children, and affects the daily-adjusted life years. Iron deficiency affects more than 3.5 billion people globally. The majority of people living with this condition are women and children in the developing world where access to food diversity and conventional medicine is limited. In 2008, the World Health Organization reported that 66.4% of pregnant and 57.3% of non-pregnant women of reproductive age suffer from anemia primarily due to iron deficiency. The long-term health impacts can be severe and may be irreversible.

### SUMMARY

The present disclosure relates to a method of cooking comprising providing a container including water, placing one or more cooking implements comprising electrolytic iron into the water, heating the water in the container to release bioavailable iron into the water from the one or more cooking implements, and removing the one or more cooking implements from the water. The present disclosure further relates to electrolytic iron cooking implements and to methods of preparing them.

It is to be understood that both the foregoing general description and the following detailed description are exemplary and explanatory only and are intended to provide further explanation of the present disclosure, as claimed.

### BRIEF DESCRIPTION OF THE DRAWINGS

The foregoing and other objects, features, aspects, and advantages of the embodiments disclosed herein will become more apparent from the following detailed description when taken in conjunction with the following accompanying drawings.

FIG. 1 is a schematic drawing of an embodiment of the electrolytic iron cooking implement of the present disclosure.

FIG. 2 is a photograph of a comparative cooking implement and an electrolytic iron cooking implement of the present disclosure.

FIG. 3 shows a device useful for preparing an embodiment of the cooking implement of the present disclosure.

FIG. 4A and FIG. 4B are electron micrographs of a comparative cooking implement and an electrolytic iron cooking implement of the present disclosure respectively.

FIG. 5A and FIG. 5B are scanning electron micrographs of a comparative cooking implement and an electrolytic iron cooking implement of the present disclosure respectively.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DESCRIPTION OF EXAMPLE EMBODIMENTS

The present disclosure describes the use of a cooking implement comprising electrolytic iron for releasing bioavailable iron into food.

Iron deficiency is one of the most significant micronutrient deficiencies in the world. However, efforts to ameliorate the condition have not resulted in improvements. Prevention and control of iron deficiency is achieved by boosting iron levels in the diet. There are two forms of dietary iron: (1) heme iron, derived from hemoglobin in blood, which is found in meat, poultry and fish; and (2) non-heme iron, which is found in plant foods such as lentils and beans. Although the body more readily absorbs heme iron, non-heme iron is usually used to supplement diets because it is more easily available and less expensive. Four types of iron supplementation have been used: (1) iron fortification of food staples like flour, rice, and pasta; (2) iron supplementation using oral tablets, often complemented with folic acid and other micronutrients that boost absorption of iron; (3) cooking food in iron pots so that iron leaches from the pots and is absorbed in the cooked food; and (4) fortified iron powders (for example, “Sprinkles”) which are sprinkled onto daily breakfast food.

Although all four supplementation options can be successful, access to these may be limited. To be effective, the supplementation options must be consistently available. However in many parts of the developing world, this is not possible. Supplements may not be available at all or only available on an intermittent basis, may be too expensive; or are culturally unacceptable. For example, adventitious sources of iron, cooking in iron pots or with iron utensils have been shown to effectively boost the intake of iron, and some of the iron leached from these sources is bioavailable. However, compliance with this approach is a significant challenge in some regions because iron pots are too heavy, too expensive, not readily available, and not culturally acceptable

An additional technique for increasing dietary iron is by adding a cooking implement, such as a fish-shaped ingot, of cast iron into a cooking pot of heated water, which releases iron into the cooking water, particularly with the addition of citrus juice. However, the iron casting process is labor intensive and time consuming, and it was found that, after repeated use, the cast iron product would become increasingly brittle and prone to fracture. Also, while iron was released into the water, most of it was not bioavailable.

Thus, the present disclosure relates to a product and method for improved release of bioavailable iron into a user's diet. In one embodiment, the method of the present disclosure comprises providing a container for cooking, such as pot or cooker, and putting water into the container. The amount of water can vary depending on the size of the container, what is cooked, and how it is prepared. In some embodiments, the water has a pH of 8 or below, and, in some preferred embodiments, the water is acidified, such as by adding acidic cooking ingredients, including various citrus acid products such as lemon or orange juice. In this way, the pH of the water can be lowered to below 7, such as below 6. In some embodiments, the pH of the water is between about 3 and 6. Other ingredients needed for cooking may also be added as desired, such as for cooking soup.

In addition, the method of the present disclosure further comprises placing or otherwise adding at least one cooking implement comprising electrolytic iron into the water. Heating the water in the container, such as by boiling, releases bioavailable iron into the water from the one or more cooking implements. The size and shape of the cooking implement can vary, as can the number of cooking implements added. For example, from 1 to 5 cooking implements, each having a weight of between about 100 gr to about 300 gr, including from about 150 gr to about 250 gr, can be added to a container having from about 0.5 L to about 3 L, including from about 0.5 L to about 2 L, or water.

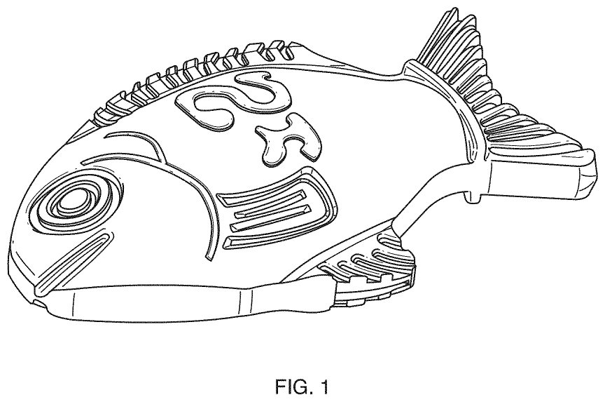

A specific embodiment of the cooking implement of the present disclosure is shown in FIG. 1. However, it should be apparent to those skilled in the art that these are merely illustrative in nature and not limiting, being presented by way of example only. Numerous modifications and other embodiments are within the scope of ordinary skill in the art and are contemplated as falling within the scope of the present disclosure. In addition, those skilled in the art should appreciate that the specific configurations are exemplary and that actual configurations will depend on the specific system. Those skilled in the art will also be able to recognize and identify equivalents to the specific elements shown, using no more than routine experimentation.

FIG. 1 is a schematic drawing of a specific embodiment of the cooking implement described herein. As shown, the cooking implement has a fish shape, recognized and considered as a symbol of luck in many cultures in which iron deficiency is high. However, the cooking implement may have any shape or features desired, depending on the target user's preferences. Surface features of opposing sides of the cooking implement may be the same or different, depending on the desired target design.

The cooking implement of the present disclosure comprises electrolytic iron, and, in a particular embodiment, comprises compacted electrolytic iron powder, which is a very different form of iron than used, for example, for preparing cast iron. In particular, typically to prepare cast iron, scrap iron collected from a variety of sources are combined and melted at high temperature, such as in a wood-fired smelter, and the resulting molten iron is poured into molds, such as sand molds, to form the cast iron product. By comparison, electrolytic iron is a powder obtained by electrodeposition of an iron anode through a ferrous sulfate solution onto a cathode. The resulting material is an amorphous, lusterless, greyish powder that is >99% pure, stable in dry air, and meets FCC specifications. The average particle size of the powder can vary, depending, for example, on the electrodeposition process conditions, and can be between about 250 nm and about 500 nm, including from about 300 nm to about 450 nm. The powder is compactable and can be formed in various shapes in a tool punch and die in a compactor at high pressure, such as between about 100-ton and 200-ton pressure.

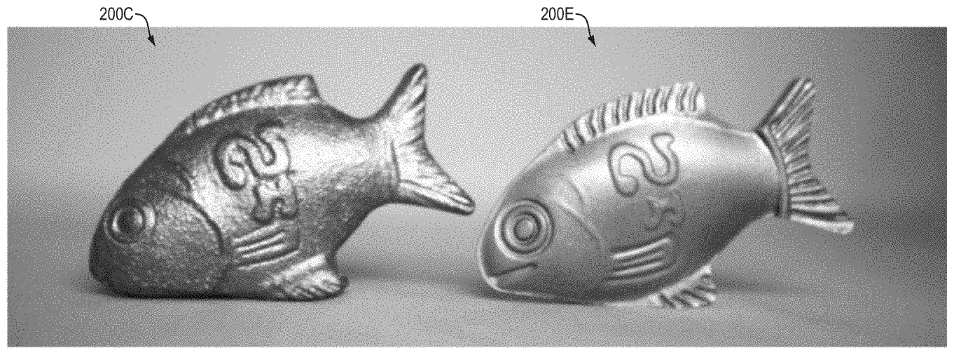

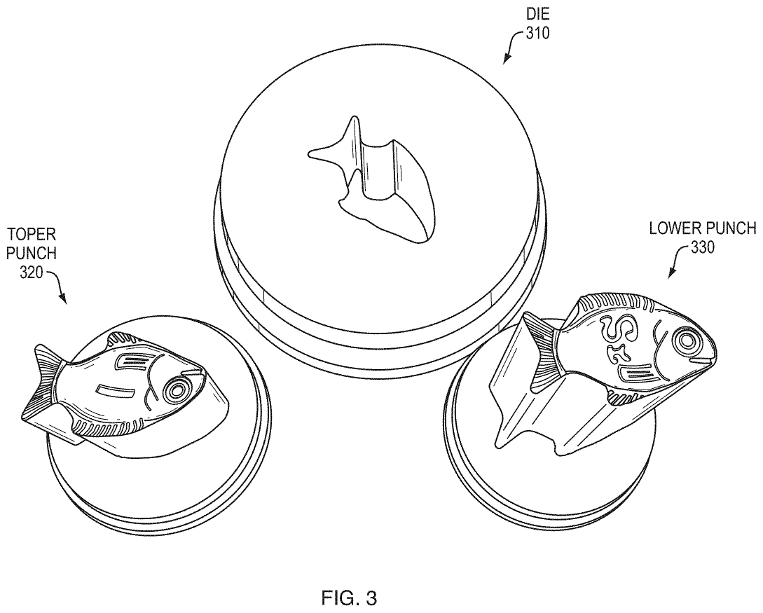

The resulting products produced from these two processes are also very different. FIG. 2 shows a side-by-side comparison of cooking implement 200C, prepared by a cast iron process, and cooking implement 200E, prepared by compaction of electrolytic iron powder in the mold set shown in FIG. 3 using die 310, upper punch 320, and lower punch 330. For example, electrolytic iron powder (95% at <325 nm particle size) was added to a die and compacted between an upper punch and a lower punch and compressed at about 150-ton pressure to produce cooking implement 200E. The detailed surface features of each punch were impressed into the resulting product. As shown in FIG. 2, cooking implement 200E (an embodiment of the present disclosure) has surprisingly been found to have a much smoother, shinier surface, thereby enabling more distinct and detailed surface features to be produced. Also, it can be made smaller and lighter in weight due to the process used, providing an economic improvement.

Chemically and physically, the cooking implement of the present disclosure has also been found to be significantly different as well, as shown in Table 1 below:

TABLE 1

| | Cooking Implement 200C | Cooking Implement 200E |
|---|---|---|
| Iron (ferrous) | 86% | 99% |
| Acid insoluble | 1.45% | 0.05% |
| Apparent | 6.5 gr/cc | 6.92 gr/cc |
| density | | |

Thus, the cooking implement of the present invention has been found to have a higher percentage of ferrous iron and much lower acid insolubility, both of which are believed to result in the improved performance properties discussed in more detail below, all the while having a higher density, thus providing the improved performance in a more compact, lighter weight form.

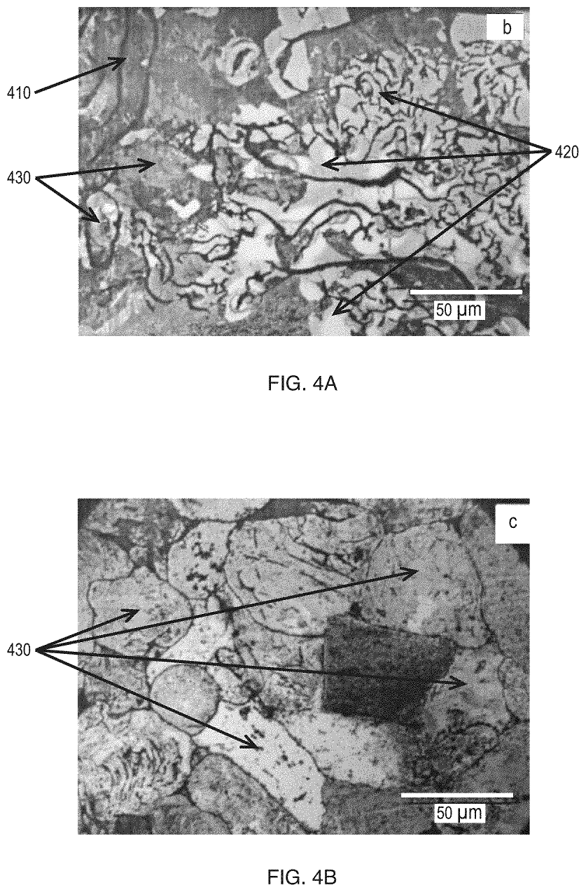

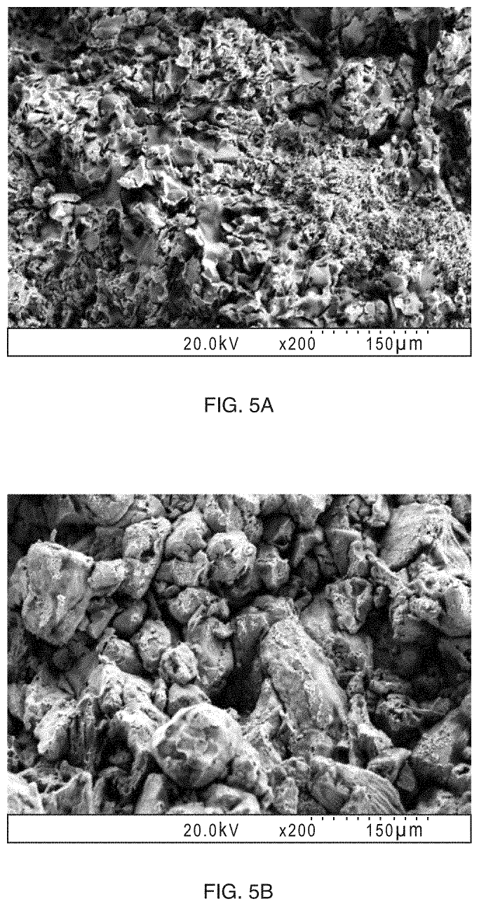

In addition, as shown in FIGS. 4A and 4B, which are representative electron micrographs of the internal structure of cooking element 200C and cooking element 200E respectively, as well as FIGS. 5A and 5B, which are representative scanning electron micrographs of the internal surface of cooking implement 200C and 200E respectively, the cooking implements used in the method of the present invention also have a very different internal compositional structure. For example, as shown in FIG. 4A, a cast iron cooking implement has been found to comprise graphite flakes 410 2-5 μm in diameter and up to 100 μm in length in a matrix of pearlite lamellae 420 and a small number of loosely defined, small ferrite particles 430 20-25 μm in diameter. This inhomogeneous mixture can also be seen in the internal surface features shown in FIG. 5A, and it was found that this composition varied across the cooking implement. By comparison, a cooking implement of the present invention, prepared from electrolytic iron powder, has been found to comprise >96% densely packed ferrite particles 430 30-60 μm in diameter (primarily 50-60 μm in diameter), with virtually no spaces or additional materials, and this compact homogeneous composition is also clearly shown in the scanning electron micrograph of FIG. 5B. Thus, physically, chemically, and structurally, the cooking implement used in the method of the present disclosure is distinct and improved over the comparative cooking implement.

Furthermore, as noted above, in the present method, heating the water in the container, particularly to boil, in which one or more electrolytic iron cooking implements have been added, causes a release of bioavailable iron into the water from the one or more cooking implements. As is known in the art, iron is present in a number of different forms, and the type of iron affects its bioavailability. For example, the intestine absorbs ferrous iron more readily than the oxidized ferric form primarily because ferrous iron is more readily dissolved and the particle size is smaller, but also because the intestinal iron receptors interact predominantly with the reduced form of iron. Ferric iron can be reduced by ferric reductase in the intestines, but the process is energy dependent, slow, and inefficient.

The electrolytic iron cooking implement used in the method of the present disclosure provides an improved release of bioavailable iron compared to a cast iron cooking implement. As shown in Table 1 above, cooking implement 200C comprises much less ferrous iron compared to a cooking implement of the present disclosure (such as 200E), and, as a result, a lower level of bioavailable iron would be expected. The amount of bioavailable iron released from electrolytic iron (estimated to be approximately 77%) is expected to be higher than from cast iron (estimated to be from 5-15%).

Surprisingly, it has been found that the cooking implements of the present disclosure, prepared from electrolytic iron, release less total iron yet provide increased levels of bioavailable iron released into the heated water. For example, electrolytic iron cooking implements similar to 200E were boiled in 1 L of water acidified with lemon juice to a pH of 3.3 in a glass container. In addition, cast iron cooking implements similar to 200C were treated in a similar way. Levels of bioavailable iron were determined and are shown in Table 2 below:

TABLE 2

| | Amount of Iron | Estimated | Amount of |
|---|---|---|---|
| Iron Source | Released | Bioavailability | Bioavailable Iron |
| Cast iron | 79.6 ± 8.7 μg/mL | 5-15% | 3.98-11.94 μg/mL |
| Electrolytic iron | 22.5 ± 1.0 μg/mL | 77% | 17.4 μg/mL |

Thus, the cooking implements used in the method of the present invention, prepared by compacting electrolytic iron, have improved physical, chemical, and compositional properties as well as provide an improved amount of bioavailable iron when boiled in water. Furthermore, it has been found that these cooking implements may be used multiple times over and over again, consistently producing similar effects, and are therefore reusable. In this way, the electrolytic iron-based cooking implements can be a powerful tool for the prevention and control of iron deficiency by boosting iron levels in the diet.

The foregoing description of preferred embodiments of the present disclosure has been presented for the purposes of illustration and description. It is not intended to be exhaustive or to limit the disclosure to the precise form disclosed. Modifications and variations are possible in light of the above teachings, or may be acquired from practice of the disclosure. The embodiments were chosen and described in order to explain the underlying principles and their practical application to enable one skilled in the art to utilize the disclosure in various embodiments and with various modifications as are suited to the particular use contemplated. It is intended that the scope of the disclosure be defined by the claims appended hereto and their equivalents.

What is claimed is:

1. A cooking implement comprising electrolytic iron, the cooking implement capable of being submerged in water in a container during cooking and releasing bioavailable iron into the water.

2. The cooking implement of claim 1, wherein the cooking implement comprises compacted electrolytic iron powder.

3. The cooking implement of claim 2, wherein the electrolytic iron powder has an average particle size of less than or equal to 400 nm.

4. The cooking implement of claim 2, wherein 95% of the electrolytic iron powder has a particle size of less than 325 nm.

5. The cooking implement of claim 1, wherein the cooking implement comprise densely packed ferrite particles having an average diameter between 30-60 microns.

6. The cooking implement of claim 1, wherein the cooking implement is reusable.

7. The cooking implement of claim 1, wherein the water has a pH of less than 8.0.

8. The cooking implement of claim 1, further comprising adding an acidifier to the water.

9. The cooking implement of claim 8, wherein the water has a pH of less than 7.0.

10. The method of claim 9, wherein the pH of the water is between 3.0 and 6.0.

11. A method of forming a cooking implement comprising
i) providing a mold set comprising a die, an upper punch, and a lower punch;
ii) placing electrolytic iron powder between the upper punch and the lower punch within the die;
iii) operating a press to compact the electrolytic powder between the upper punch and the lower punch to form the cooking implement; and
iv) removing the cooking implement from the die.

12. The method of claim 11, wherein the electrolytic iron powder has an average particle size of less than or equal to 400 nm.

13. The method of claim 11, wherein 95% of the electrolytic iron powder has a particle size of less than 325 nm.

14. The method of claim 11, wherein the cooking implement comprise densely packed ferrite particles having an average diameter between 30-60 microns.

15. The method of claim 11, wherein the upper punch and the lower punch have detailed surface features, and wherein the method further comprises impressing the detailed surface features onto opposing surfaces of the cooking implement.

16. The method of claim 11, wherein the cooking implement is capable of being submerged in water in a container during cooking and releasing bioavailable iron into the water.

17. A mold set comprising a die, an upper punch, and a lower punch configured to compact electrolytic iron to form a cooking implement, wherein the upper punch and the lower punch have detailed surface features impressible onto opposing surfaces of the cooking implement during compaction in a press.

18. The mold set of claim 17, wherein the detailed surface features of the upper punch differ from the detailed surface features of the lower punch.

19. The mold set of claim 17, wherein the upper punch and the lower punch have detailed fish surface features.

20. The mold set of claim 17, wherein the mold has a fish shape.
